(19) United States
(12) Patent Application Publication
(10) Pub. No.: US 2014/0336045 A1
(43) Pub. Date: Nov. 13, 2014

(54) Perovskite and Mullite-like Structure Catalysts for Diesel Oxidation and Method of Making Same

(71) Applicants: Zahra Nazarpoor, Camarillo, CA (US); Stephen J. Golden, Santa Barbara, CA (US)

(72) Inventors: Zahra Nazarpoor, Camarillo, CA (US); Stephen J. Golden, Santa Barbara, CA (US)

(73) Assignee: CDTi, Ventura, CA (US)

(21) Appl. No.: 13/891,668

(22) Filed: May 10, 2013

(51) Int. Cl. B01J 23/34

(52) U.S. Cl. CPC B01J 23/34
USPC 502/303; 502/302

(57) ABSTRACT

Disclosed here are material formulations of use in the conversion of exhaust gases. A catalyst is formed by using a perovskite structure having the general formula ABO3 or a mullite structure having the general formula of AB2O5 where components “A” and “B” may be any suitable non-platinum group metals. Suitable materials may include Yttrium, Lanthanum, Silver, Manganese and formulations thereof.

### TECHNICAL FIELD

This disclosure relates generally to catalytic converters and, more particularly to catalytic converters which are free of any platinum group metals.

### BACKGROUND INFORMATION

Emission standards for unburned contaminants, such as hydrocarbons, carbon monoxide and nitrogen oxide, continues to become more stringent. In order to meet such standards, Diesel oxidation catalysts, lean NOx traps and Continues regenerable traps are used in the exhaust gas lines of internal combustion engines. These catalysts promote the oxidation of unburned hydrocarbons and carbon monoxide as well as the oxidation of nitrogen oxides in the exhaust gas stream to reduce the engine generated pollutants. oxidation of NO to NO2 may be used for removal of carbon soot in continues regenerable trap. One of the major limitations of current catalysts is that the Platinum Group Metals (PGM) used in their fabrication have very high demand and increasing prices.

Therefore, there is a continuing need to provide cost effective catalyst systems that provide sufficient conversion so that HC, NOx, and CO emission standards can be satisfied.

### SUMMARY

Zero platinum group metals (ZPGM) catalyst systems are disclosed.

ZPGM catalyst may be formed by using a perovskite structure having the general formula ABO3 where components “A” and “B” may be any suitable non-platinum group metals. Materials suitable for use as catalyst include Yttrium, (Y), Lanthanum (La), Silver (Ag), Manganese (Mn) and suitable combinations thereof.

ZPGM catalyst may also be formed by partially substituting element “A” of the structure with suitable non-platinum group metal in order to form a structure having the general formula A₁₋ₓMₓB₂O₃.

ZPGM catalyst may also be formed by using a mullite structure having the general formula of AB2O5 where components “A” and “B” may be any suitable non-platinum group metals. Materials suitable for use as catalyst include Yttrium, (Y), Lanthanum (La), Silver (Ag), Manganese (Mn) and suitable combinations thereof.

ZPGM catalyst may also be formed by partially substituting element “A” of the structure with suitable non-platinum group metal in order to form a structure having the general formula A₁₋ₓMₓB₂O₅.

Suitable known in the art chemical techniques, deposition methods and treatment systems may be employed in order to form the disclosed ZPGM catalyst.

The present disclosure also pertains to a method of making a catalyst powder sample by precipitation of ZPGM catalyst on support materials.

Support materials of use in catalysts containing one or more of the aforementioned combinations may include ZrO2, doped ZrO2 with Lanthanid group metals, alumina and doped alumina, TiO2 and doped TiO2, Nb2O5, and Nb2O5-ZrO2, or a combinations thereof.

ZPGM catalyst systems may oxidize carbon monoxide, hydrocarbons and nitrogen oxides that may be included in diesel exhaust gases.

ZPGM catalyst systems may be used for NOx storage application.

Numerous other aspects, features and advantages of the present disclosure may be made apparent from the following detailed description, taken together with the drawing figures.

### BRIEF DESCRIPTION OF THE DRAWINGS

The present disclosure can be better understood by referring to the following figures. The components in the figures are not necessarily to scale, emphasis instead being placed upon illustrating the principles of the invention. In the figures, any reference numerals designate corresponding parts throughout different views.

FIG. 1 illustrates a method of preparation for a perovskite powder sample, according to an embodiment.

FIG. 2 is an XRD diagram for a mullite structure, according to an embodiment.

FIG. 3 is a graph illustrating conversion percentages for NO, CO and HC in a (Y1-xAgx)MnO3 powder sample, according to an embodiment.

FIG. 4 is a graph showing NO conversion in a (Y1-xAgx)MnO3 powder sample, according to an embodiment and another graph showing NO2 production in a (Y1-xAgx)MnO3 powder sample, according to an embodiment.

FIG. 5 is a comparison of NO conversion in a (Y1-xAgx)MnO3 aged and fresh powder sample, according to an embodiment

FIG. 6 is showing NO adsorption at low temperature by (Y1-xAgx)MnO3 powder sample with respect to time.

FIG. 7 shows a graph of CO and NO conversion light-off in a (Y1-xAgx)MnO3 powder sample using a modified exhaust condition, according to an embodiment and a graph for NO conversion for Diesel exhaust condition and a modified diesel exhaust condition using a (Y1-xAgx)MnO3 powder sample, according to an embodiment.

FIG. 8 is a CO and HC conversion graph of a ((LA0.5AG0.5)Mn2O5) mullite-like powder sample in a lean exhaust, according to an embodiment.

### DETAILED DESCRIPTION

Disclosed here are catalyst materials that may be of use in the conversion of exhaust gases, according to an embodiment.

The present disclosure is here described in detail with reference to embodiments illustrated in the drawings, which form a part hereof. In the drawings, which are not necessarily to scale or to proportion, similar symbols typically identify similar components, unless context dictates otherwise. Other embodiments may be used and/or other changes may be made without departing from the spirit or scope of the present disclosure. The illustrative embodiments described in the detailed description are not meant to be limiting of the subject matter presented herein.

### DEFINITIONS

As used here, the following terms have the following definitions:

“Exhaust” refers to the discharge of gases, vapor, and fumes that may include hydrocarbons, nitrogen oxide, and/or carbon monoxide.

“Conversion” refers to the chemical alteration of at least one material into one or more other materials.

“Catalyst” refers to one or more materials that may be of use in the conversion of one or more other materials.

“Carrier Material Oxide (CMO)” refers to support materials used for providing a surface for at least one catalyst.

“Oxygen Storage Material (OSM)” refers to a material able to take up oxygen from oxygen rich streams and able to release oxygen to oxygen deficient streams.

“T50” refers to the temperature at which 50% of a material is converted.

“Oxidation Catalyst” refers to a catalyst suitable for use in converting at least hydrocarbons and carbon monoxide.

“Zero Platinum Group (ZPGM) Catalyst” refers to a catalyst completely or substantially free of platinum group metals.

“Platinum Group Metals (PGMs)” refers to platinum, palladium, ruthenium, iridium, osmium, and rhodium.

### DESCRIPTION

Various example embodiments of the present disclosure are described more fully with reference to the accompanying drawings in which some example embodiments of the present disclosure are shown. Illustrative embodiments of the present disclosure are disclosed herein. However, specific structural and functional details disclosed herein are merely representative for purposes of describing example embodiments of the present disclosure. This disclosure however, may be embodied in many alternate forms and should not be construed as limited to only the embodiments set forth herein.

A catalyst in conjunction with a sufficiently lean exhaust (containing excess oxygen) may result in the oxidation of residual HC and CO to carbon dioxide (CO2) and water (H2O), where equations (1) and (2) take place.

2CO+O₂→2CO2 (1)

2CₘHₙ+(2m+/2n)O₂→2mCO₂+nH2O (2)

Although dissociation of NO into its elements may be thermodynamically favored, under practical lean conditions this may not occur. Active surfaces for NO dissociation include metallic surfaces, and dissociative adsorption of NO, equation (3), may be followed by a rapid desorption of N2, equation (4). However, oxygen atoms may remain strongly adsorbed on the catalyst surface, and soon coverage by oxygen may be complete, which may prevent further adsorption of NO, thus halting its dissociation. Effectively, the oxygen atoms under the prevailing conditions may be removed through a reaction with a reductant, for example with hydrogen, as illustrated in equation (5), or with CO as in equation (6), to provide an active surface for further NO dissociation.

2NO→2N_{ads}+2Oads (3)

N_{ads}+N_{ads}→N2 (4)

Oads+H₂→H2O (5)

Oads+CO→CO2 (6)

Materials that may allow one or more of these conversions to take place may include ZPGM catalysts, including catalysts containing Yttrium (Y), Lanthanum (La), Manganese (Mn), Silver (Ag) and combinations thereof. Catalysts containing the aforementioned metals may include any suitable Carrier Material Oxides, including alumina and doped alumina, TiO2 and doped TiO2, ZrO2, doped ZrO2 with Lanthanid group metals, Nb2O5, Nb2O5-Zr02, Cerium Oxides, tin oxide, silicon dioxide, zeolite, and combinations thereof. Catalysts containing the aforementioned metals and Carrier Material Oxides may be suitable for use in conjunction with catalysts containing PGMs. Catalysts with the aforementioned qualities may be used in a washcoat or overcoat, in ways similar to those described in US 20100240525.

According to an embodiment, ZPGM catalyst may include a perovskite structure having the general formula ABO₃ or related structures resulting from the partial substitution of the A site. Partial substitution of the A site with M element will yield the general formula A₁₋ₓMₓBO₃. “A” may include, Yttrium, lanthanum, strontium, or mixtures thereof. “B” may include a single transition metal, including manganese, cobalt, chromium, or mixture thereof. M may include silver, iron, Cerium, niobium or mixtures thereof; and “x” may take values between 0 and 1. The perovskite or related structure may be present in about 1% to about 30% by weight.

For example, components created using a perovskite structure may be YMnO₃ or LaMnO₃, which follows the general formula ABO₃. The “A” component may be partially substituted with another components such as, silver to form Y₁₋ₓAgₓMnO₃, which follows the formula A₁₋ₓMₓBO₃.

In another embodiment, ZPGM catalyst may include a Mullite-like structure having the general formula AB2O5 or related structures resulting from the partial substitution of the A site. Partial substitution of the A site with M element will yield the general formula A₁₋ₓMₓB₂O₅. “A” may include, Yttrium, lanthanum, strontium, or mixtures thereof. “B” may include a single transition metal, including manganese, cobalt, chromium, or mixture thereof. M may include silver, iron, Cerium, niobium or mixtures thereof; and “x” may take values between 0 and 1.

For example, components created using a mullite-like structure may be YMn₂O₅ or LaMn₂O₅, which follow the general formula AB₂O₅. The “A” component may be partially substituted with another components such as silver to form Y₁₋ₓAgₓMn₂O₅, which follows the general formula A₁MₓB₂O₅.

### CATALYST PREPARATION

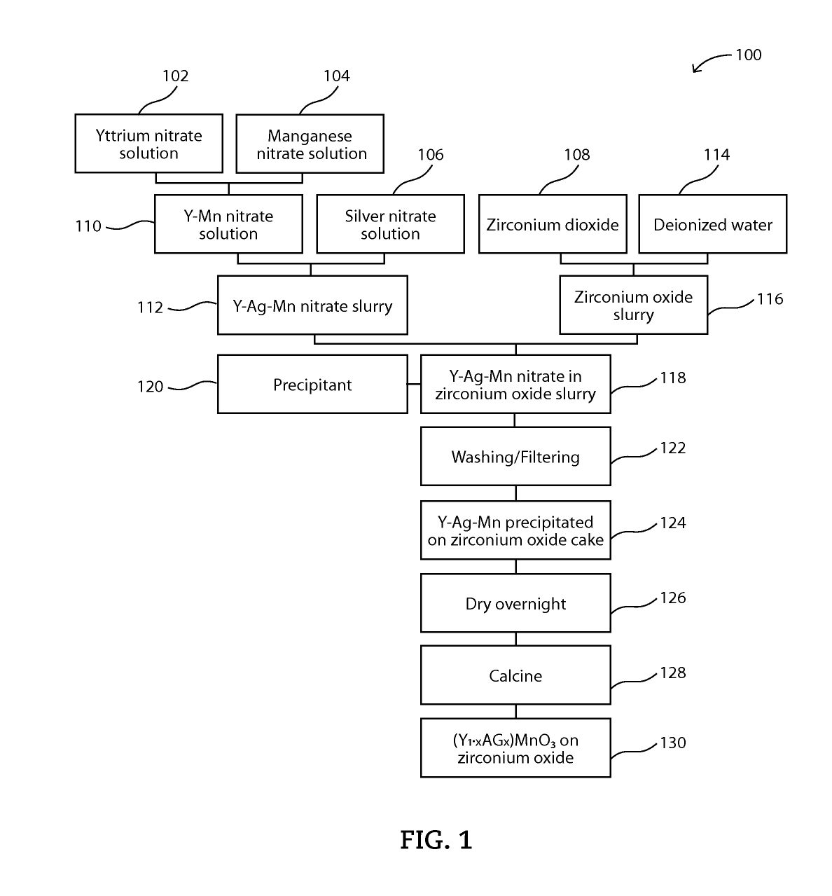

FIG. 1 is an embodiment of preparation method 100 for perovskite powder sample of formula A₁₋ₓMₓBO₃on a zirconium oxide 108 as support material using a yttrium nitrate solution 102, a manganese nitrate solution 104 and a Silver nitrate solution 106. In another embodiment, yttrium nitrate may be substituted by lanthanum nitrate. The process may begin by mixing a suitable amount of yttrium nitrate solution 102 with manganese nitrate solution 104. The mixing may take from about 1 hour to 2 hours at room temperature and shown as Y—Mn nitrate solution 110. Y—Mn nitrate solution 110 may then be mixed with a suitable amount of silver nitrate solution 106 which is shown as Y—Ag—Mn nitrate solution 112. The mixing may take from about 1 hour to 2 hours at room temperature. Zirconium oxide 108 may be mixed with deionized water 114 to form Zirconium oxide slurry 116. Zirconium oxide slurry 116 may then be mixed with Y—Ag—Mn nitrate solution 112 in order to form Y—Ag—Mn Nitrate in Zirconium oxide slurry 118. The Yttrium (or lanthanum) may have loading of 1 to 30 percentage by weight, while silver may have loading of 1 to 10 percentage by weight and manganese may have a loading of 1 to 20 percentage by weight. A precipitant 120 may be used in order to precipitate all ZPGM metals on the support oxide. Some examples of compounds that may be used as precipitants may include ammonium hydroxide, tetraethyl ammonium hydroxide, other tetralkyl ammonium salts, ammonium acetate, ammonium citrate, sodium hydroxide and other suitable compounds. Preferred solution for precipitation may be tetraethyl ammonium hydroxide. The precipitated slurry may be aged for 2 hours to 4 hours at room temperature and PH between 6.0 and 7.0. The slurry may then be filtered and washed 122 using any conventional methods known in the art. The precipitated cake 124 may be dried overnight 126 at a temperature about 120° C. and may then be calcined 128 for about 4 hours at a temperature between 600° C. and 800° C., preferably 700° C. to produce (Y1-xAgx)MnO3 130 powder supported on zirconium oxide 108, where x=0 to 0.5.

The co-precipitation technique may also be used for preparation of a mullite powder sample of formula A₁₋ₓMₓB₂O₅on a zirconium oxide 108 as support material using a yttrium nitrate solution 102, a Manganese Nitrate Solution 104 and a Silver nitrate solution 106. In an embodiment, yttrium nitrate may be substituted by lanthanum nitrate. However, the Yttrium (or lanthanum) may have loading of 1 to 20 percentage by weight, while silver may have loading of 1 to 20 percentage by weight and manganese may have a loading of 1 to 30 percentage by weight. Appropriate amount of nitrate solution of all metal components may be added to a stabilizer solution. Some examples of compounds that can be used as stabilizer solutions may include polyethylene glycol, polyvinyl alcohol, poly(N-vinyl-2pyrrolidone)(PVP), polyacrylonitrile, polyacrylic acid, multilayer polyelectrolyte films, poly-siloxane, oligosaccharides, poly(4-vinylpyridine), poly(N,Ndialkylcarbodiimide), chitosan, hyper-branched aromatic polyamides and other suitable polymers. The weight ratio of metals to stabilizer may be varied from 0.5 to 2. The small amount of octanol solution may be used as de-foaming agent. The stabilized metal solution may then be precipited on zirconium oxide support by using ammonium hydroxide, tetraethyl ammonium hydroxide, other tetralkyl ammonium salts, ammonium acetate, ammonium citrate, or other suitable compounds. The precipitated slurry may then be aged for about 2 hours to about 4 hours at room temperature and PH between 8.0 and 10.0. The slurry may then be filtered and washed 122 using any conventional methods known in the art. The precipitated cake 124 may be dried overnight 126 at a temperature about 120° C. and may then be calcined 128 for about 4 hours at a temperature between 500° C. and 800 C, preferably 750° C. to produce (A1-xAgx)Mn2O5 130 powder supported on zirconium oxide, where A may be yttrium or lanthanum, and x=0 to 0.5.

### XRD ANALYSIS

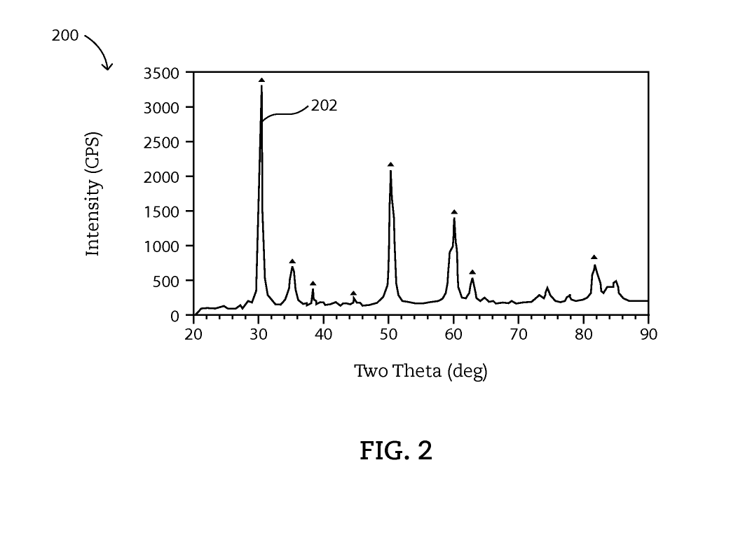

FIG. 2 shows XRD Graph 200 for (Y0.5Ag0.5)Mn2O5 202. The peaks shown with triangle corresponds to mullite phase of Y—Ag—Mn oxide. All peaks assigned to mullite diffraction peaks may be considered as shifted peaks of yttrium manganese oxide Y2Mn2O7. The shifting of Y2Mn2O7 diffraction peaks to the lower diffraction angles may be explained by the partial substitution of silver in the yttrium-manganese oxide structure.

### EXAMPLES

In example #1, a perovskite powder sample of (Y1-xAgx)MnO3 where x=0.2 is prepared and tested under a simulated DOC condition. The feed stream may include 100 ppm NO, 1500 ppm CO, 430 pm C3H6 as feed hydrocarbon, 4% CO2, 4% H20 and 14% O2.

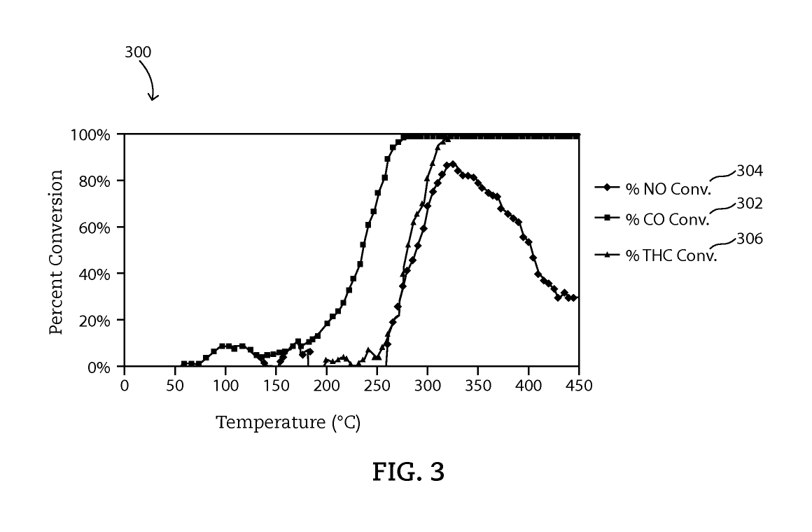

FIG. 3 shows the conversion percentage variation 300 for Carbon Monoxide (CO conversion 302), Nitrogen oxides (NO conversion 304) and Hydrocarbons (HC conversion 306) at different temperatures using the fresh powder sample from example 1.

The light-off test shows that T50 for CO may be at about 232° C., T50 for HC may be at about 278° C. and T50 for NO may be at about 287° C. The NO conversion may be related to the oxidation of NO to NO2. NH3 or N20 were not formed under this exhaust condition. The decreasing of NO conversion at temperature above 320° C. may be related to desorption of NO stored initially by catalyst.

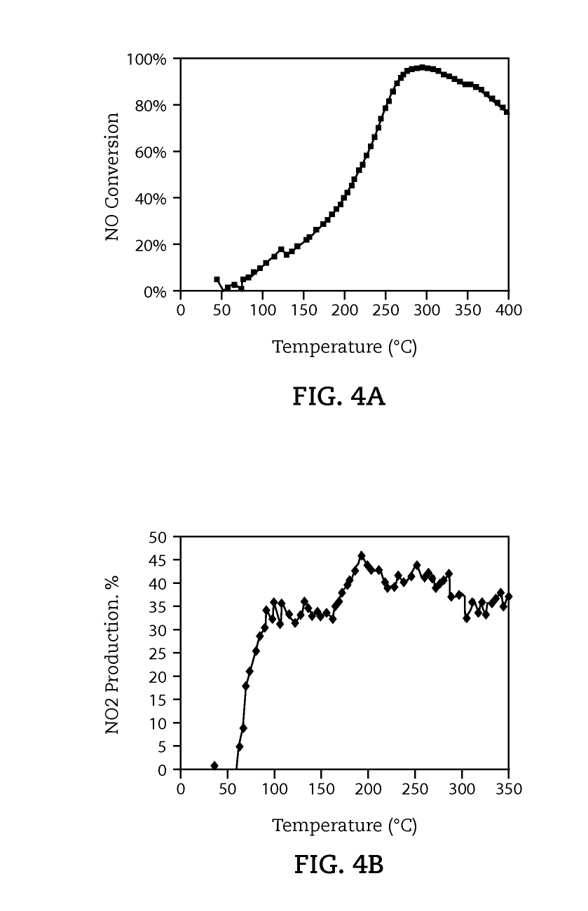

FIG. 4A shows light-off curve for NO conversion under NO oxidation reaction. A fresh perovskite powder sample of (Y₁₋ₓAgₓ)MnO₃ from example 1 may be tested under NO oxidation with 100 ppm NO and 14% O2 in feed stream. The graph may represent a 96% conversion rate of NO at a temperature of about 250 ° C. .

FIG. 4B shows the percentage of NO₂ production during NO oxidation test for perovskite sample of example 1. FIG. 4B illustrates the formation of NO2 at low temperature as 50° C.

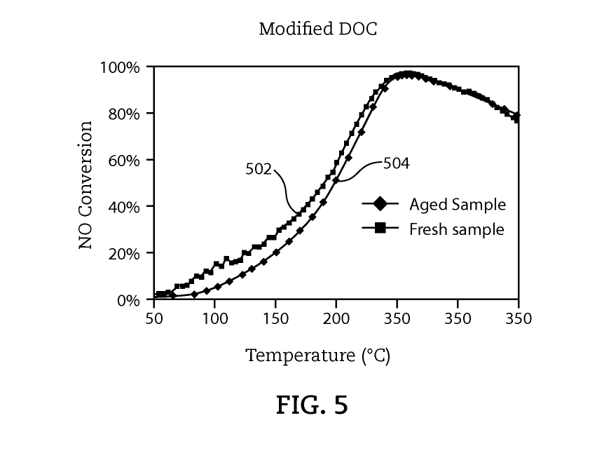

FIG. 5 shows light-off curve for NO conversion under NO oxidation reaction. A perovskite powder sample of (Y₁₋ₓAgₓ)MnO₃ of example 1 may be tested under NO oxidation with 100 ppm NO and 14% O2 in feed stream. FIG. 5 compares a fresh sample 502 and aged sample 504. Aged sample 504 may be treated at 900° C. for 4 hours under dry air. The NO conversion light-off may show that aging does not affect significantly the oxidation of NO to NO2.

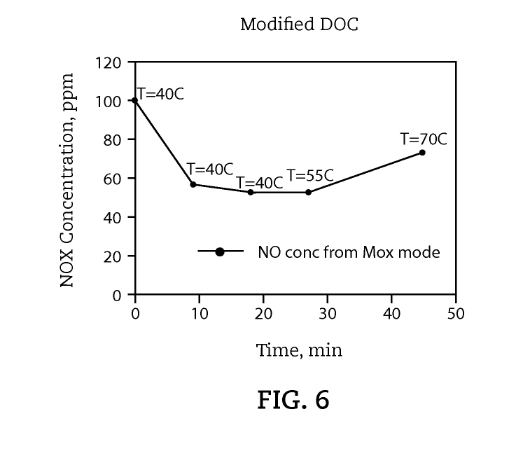

FIG. 6 shows a variation of NOx concentration by the reaction time at low temperature between 40 ° C. and 70° C. under NO oxidation reaction condition. A fresh perovskite powder sample of (Y₁₋ₓAgₓ)MnO₃ where x=0.2 may be tested. The NO concentrations may decrease from 100 ppm in feed stream at temperature of about 40° C. by the time which may correspond to NO trapping by catalyst at this temperature. The increasing NOx concentration at 70 C corresponds to formation of NO₂ from oxidation of NO.

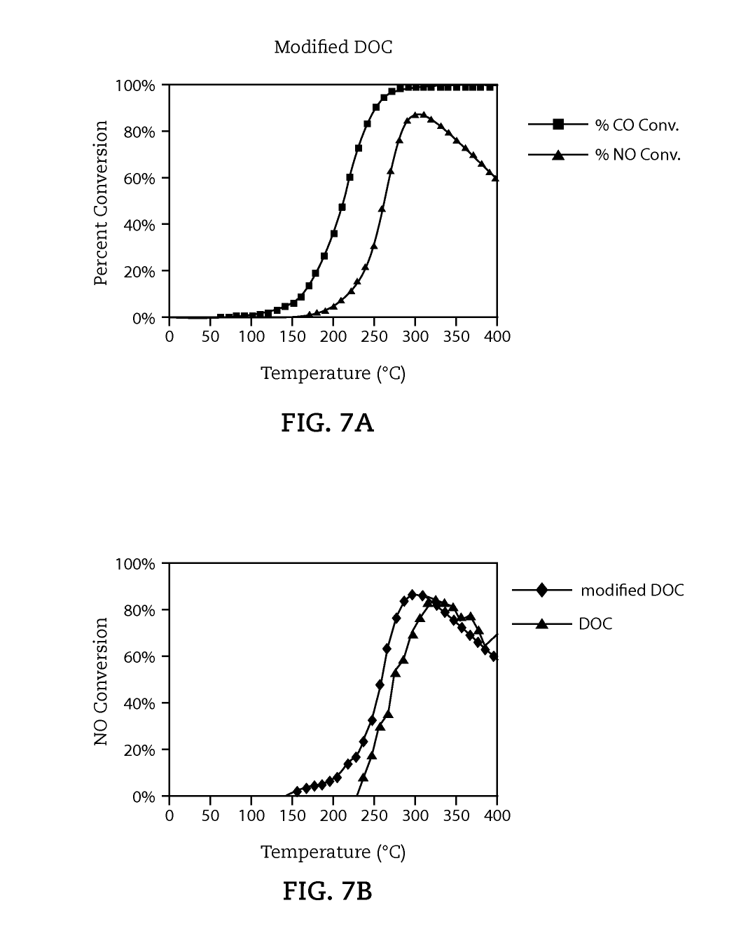

In FIG. 7A, a fresh perovskite powder sample of (Y₁₋ₓAgₓ)MnO₃ of example#1 is prepared and tested under a modified DOC condition. The feed stream contain 100 ppm NO, 1500 ppm CO, 4% CO2, 4% H20 and 14% O2. No hydrocarbon was used in feed stream. FIG. 7A shows a T50 for CO at 215° C. and a T50 for NO at 260° C.

FIG. 7B shows the NO conversion light-off for this sample under simulated DOC condition with and without hydrocarbon present in the system. The results may show that hydrocarbon does not significantly decrease the conversion rate of NO. The results may show that NO conversion may go through NO oxidation rather than reduction by hydrocarbon.

In example #2, A mullite powder samples of (La₁₋ₓAgₓ)Mn₂O₅ where x=0.5 may be prepared and tested under a simulated DOC condition. The feed stream may include 100 ppm NO, 1500 ppm CO, 430 pm C3H6 as feed hydrocarbon, 4% CO2, 4% H2O and 14% O2.

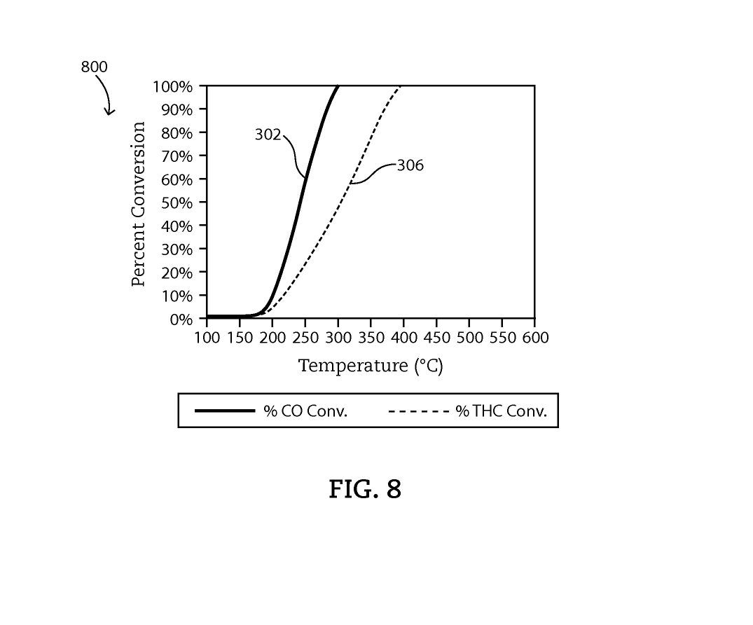

FIG. 8 shows the conversion percentage variation 800 for Carbon Monoxide (CO conversion 302) and Hydrocarbons (HC conversion 306) at different temperatures using the fresh powder sample from example 2. The light-off test shows that T50 for CO may be at about 240° C. and a T50 for HC may be at about 310° C. NO conversion may not be observed for the powder sample of example#2.

Despite the perovskite powder of example#1, the mullite powder sample of example#2 may not be active in oxidation of NO.

What is claimed is:

1. A zero platinum group metal (ZPGM) catalyst system, comprising:
a substrate;
a washcoat suitable for deposition on the substrate, comprising at least one oxide solid selected from the group consisting of at least one of a carrier material oxide, and a ZPGM catalyst; and
an overcoat suitable for deposition on the substrate, comprising at least one overcoat oxide solid selected from the group consisting of at least one of a carrier material oxide, and a ZPGM catalyst;
wherein at least one of the ZPGM catalysts comprises at least one perovskite structured compound having a formula ABO₃, wherein A is selected from the group consisting of at least one of yttrium, lanthanum, silver, magnesium, and mixtures thereof.

2. The catalyst system of claim 1, wherein the carrier material oxide is selected from the group consisting of ZrO2, doped ZrO2 with lanthanid group metals, alumina, doped alumina, TiO₂ doped TiO₂, Nb₂O₅, Nb₂O₅-ZrO₂, and combinations thereof.

3. The catalyst system of claim 1, wherein at least one of the ZPGM catalysts is deposited by co-precipitation at a temperature of about 600° C. to about 800° C.

4. The catalyst system of claim 1, wherein at least one of the ZPGM catalysts is deposited by co-precipitation at a temperature of about 500° C. to about 800° C. .

5. The catalyst system of claim 1, wherein the T50 conversion temperature for carbon monoxide is less than 250° Celsius.

6. The catalyst system of claim 1, wherein the T50 conversion temperature for NO is less than 300° Celsius.

7. A zero platinum group metal (ZPGM) catalyst system, comprising:
a substrate;
a washcoat suitable for deposition on the substrate, comprising at least one oxide solid selected from the group consisting at least one of a carrier metal oxide, and a ZPGM catalyst; and
an overcoat suitable for deposition on the substrate;
wherein the ZPGM catalyst comprises at least one structured compound having the formula A₁₋ₓMₓBO₃, wherein x is 0 to 1. and wherein each of A, B and M is selected from the group consisting at least one of yttrium, lanthanum, silver, manganese, and combinations thereof.

8. The catalyst of claim 7, wherein the overcoat further comprises at least one overcoat oxide solid selected from the group consisting at least one of a carrier metal oxide, and a ZPGM catalyst.

9. The catalyst system of claim 7, wherein the T50 conversion temperature for carbon monoxide is less than 250° Celsius.

10. The catalyst system of claim 7, wherein the T50 conversion temperature for NO is less than 300° Celsius.

11. A zero platinum group metal (ZPGM) catalyst system, comprising:
a substrate;
a washcoat suitable for deposition on the substrate, comprising at least one oxide solid selected from the group consisting at least one of a carrier metal oxide, and a ZPGM catalyst; and
an overcoat suitable for deposition on the substrate, comprising at least one overcoat oxide solid selected from the group consisting at least one of a carrier metal oxide, and a ZPGM catalyst;
wherein at least one of the ZPGM catalysts comprises at least one mullite structured compound having the formula AB₂O₅, wherein each of A and B is selected from the group consisting at least one of yttrium, lanthanum, silver, manganese, and combinations thereof.

12. The catalyst system of claim 11, wherein at least one of the ZPGM catalysts oxidizes carbon monoxide, hydrocarbons or nitrogen oxides.

13. The catalyst system of claim 11, wherein the T50 conversion temperature for carbon monoxide is less than 250° Celsius.

14. The catalyst system of claim 11, wherein the T50 conversion temperature for NO is less than 300° Celsius.

15. A zero platinum group metal (ZPGM) catalyst system, comprising:
a substrate;
a washcoat suitable for deposition on the substrate, comprising at least one oxide solid selected from the group consisting at least one of a carrier metal oxide, and a ZPGM catalyst; and
an overcoat suitable for deposition on the substrate;
wherein the ZPGM catalyst comprises at least one structured compound having the formula A₁₋ₓMₓB₂O₅, wherein x is 0 to 1 and wherein each of A and B is selected from the group consisting at least one of yttrium, lanthanum, silver, manganese, and combinations thereof.

16. The catalyst system of claim 15, wherein the ZPGM catalyst oxidizes carbon monoxide, hydrocarbons or nitrogen oxides.

17. The catalyst system of claim 15, wherein the T50 conversion temperature for carbon monoxide is less than 250° Celsius.

18. The catalyst system of claim 15, wherein the T50 conversion temperature for NO is less than 300° Celsius.
